(19) United States
(12) Patent Application Publication
(10) Pub. No.: US 2018/0347757 A1
(43) Pub. Date: Dec. 6, 2018

(54) COMPOSITE PRESSURE VESSEL ASSEMBLY WITH AN INTEGRATED HEATING ELEMENT

(71) Applicant: UNITED TECHNOLOGIES CORPORATION, Farmington, CT (US)

(72) Inventors: Wenping Zhao, Glastonbury, CT (US); Bart Antonie van Hassel, Weatogue, CT (US); Ellen Y. Sun, South Windsor, CT (US)

(21) Appl. No.: 15/779,124

(22) PCT Filed: Nov. 25, 2015
(86) PCT No.: PCT/US2015/062656

§ 371 Date: May 25, 2018

(51) Int. Cl. F17C 11/00

(52) U.S. Cl. CPC F17C 11/005; F17C 2260/018; F17C 2201/0152; F17C 2201/0166; F17C 2201/056; F17C 2201/058; F17C 2203/0604; F17C 2203/0621; F17C 2203/0663; F17C 2221/012; F17C 2221/031; F17C 2221/033; F17C 2221/035; F17C 2227/0304; F17C 2227/0381; F17C 11/007

(57) ABSTRACT

A pressure vessel assembly includes a composite layer surrounding at least one chamber. A heating element is embedded in the composite layer for extracting gas from the chamber.

### BACKGROUND

The present disclosure relates to a pressure vessel assembly and more particularly to a pressure vessel assembly with an integrated heating element.

Pressure vessels may serve as storage media (e.g., gas) for a wide variety of consumer, commercial, and industrial processes. In order to store sufficient gas for any operation within a given volume, the gas is stored at high pressure. Traditionally, pressure vessels have a typical spherical or cylindrical design that evenly distributes stress in the containment perimeter. Unfortunately, such tanks do not use allocated space efficiently. For example, a spherical vessel fills a cubic space with about fifty-two percent efficiency, and a cylindrical vessel fills a rectangular volume with approximately seventy-eight percent efficiency. More recent improvements in pressure vessels that generally conform to a rectangular volume may fill the space with about ninety percent efficiency relative to a true rectangular volume.

An absorbent may be placed inside the pressure vessel to further improve storage efficiency of the pressurized gas. To assist in extracting the gas from the vessel, the absorbent may be heated by various means.

The designs of non-spherical/cylindrical pressure vessels to support high internal pressure are complex, including variable-curvature external surfaces and internal structure to transfer stresses. The large size of a high conformable vessels and the complicated shapes makes manufacturing challenging. Moreover, the addition of absorbents with a heating means contributes toward design and manufacturing complexity and cost.

### SUMMARY

A pressure vessel assembly according to one, non-limiting, embodiment of the present disclosure includes a first composite layer surrounding at least one chamber; and a first heating element embedded in the first composite layer.

Additionally to the foregoing embodiment, the pressure vessel assembly includes a first absorbent disposed in at least one of the at least one chamber.

In the alternative or additionally thereto, in the foregoing embodiment, the first composite layer comprises a polymer matrix composite.

In the alternative or additionally thereto, in the foregoing embodiment, the first heating element is selected from the group comprising metal wire, copper foil and carbon nano tubes.

In the alternative or additionally thereto, in the foregoing embodiment, the first composite layer comprises continuous carbon fibers, and the heating element includes the continuous carbon fibers.

In the alternative or additionally thereto, in the thieving embodiment, the pressure vessel assembly is configured to store natural gas and the first heating element is configured to heat the absorbent to extract the natural gas.

In the alternative or additionally thereto, in the foregoing embodiment, the first heating element is configured to be a portion of a vessel structural health monitoring device.

In the alternative or additionally thereto, in the foregoing embodiment the pressure vessel assembly includes a first liner defining a first chamber of the at least one chamber, and wherein the first liner is encompassed by the first composite layer.

In the alternative or additionally thereto, in the foregoing embodiment, the first liner is selected from the group comprising, blow molded plastic and injection molded plastic.

In the alternative or additionally thereto, in the foregoing embodiment the pressure vessel assembly includes a second liner defining a second chamber of the at least one chamber, and wherein the first and second liners are encompassed by the first composite layer.

In the alternative or additionally thereto, in the foregoing: embodiment the pressure vessel assembly includes a second liner defining a second chamber of the at least one chamber; and a second composite layer joined with and enveloping the second liner, and wherein the first liner is joined and enveloped by the first composite layer, and portions of the first and second composite layers are joined.

In the alternative or additionally thereto, in the foregoing embodiment the pressure vessel assembly includes a second heating element embedded in the second composite layer.

In the alternative or additionally thereto, in the foregoing embodiment the pressure vessel assembly includes a third composite layer joined with and enveloping the first and second composite layers.

In the alternative or additionally thereto, in the foregoing embodiment the pressure vessel assembly includes a second absorbent disposed in the second chamber.

In the alternative or additionally thereto, in the foregoing embodiment the pressure vessel assembly includes a second absorbent disposed in the second chamber.

In the alternative or additionally thereto, in the foregoing embodiment, the third composite layer comprises a glass fiber.

A composite pressure vessel assembly according to another, non-limiting, embodiment includes a liner defining a chamber and comprising blow molded plastic; a layer joined with and enveloping the liner, and wherein the layer comprises a polymer matrix composite; an absorbent disposed in the chamber; and a heating element embedded in the layer.

Additionally to the foregoing embodiment, the polymer matrix composite includes a reinforcement fiber selected from the group comprising a carbon fiber, a glass fiber and an aramid fiber.

In the alternative or additionally thereto, in the foregoing embodiment, the heating element is configured to convert electrical energy to thermal energy and is selected from the group comprising metal wire, copper foil and carbon nano tubes.

In the alternative or additionally thereto, in the foregoing embodiment, the heating element is configured to apply hydronic heat and includes tubes embedded in the layer for flowing a heated fluid.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a pressure vessel assembly configured to store a pressurized fluid according to an exemplary, embodiment of the invention;

FIG. 2 is an exploded perspective view of liners of the pressure vessel assembly;

FIG. 3 is a cross section of the liners;

FIG. 4 is a perspective cross section of the liners with a mid-layer applied;

FIG. 5 is a perspective cross section of the pressure vessel assembly; and

FIG. 6 is an enlarged partial cross section taken from the circle identified as 6 in FIG. 5.

### DETAILED DESCRIPTION OF THE INVENTION

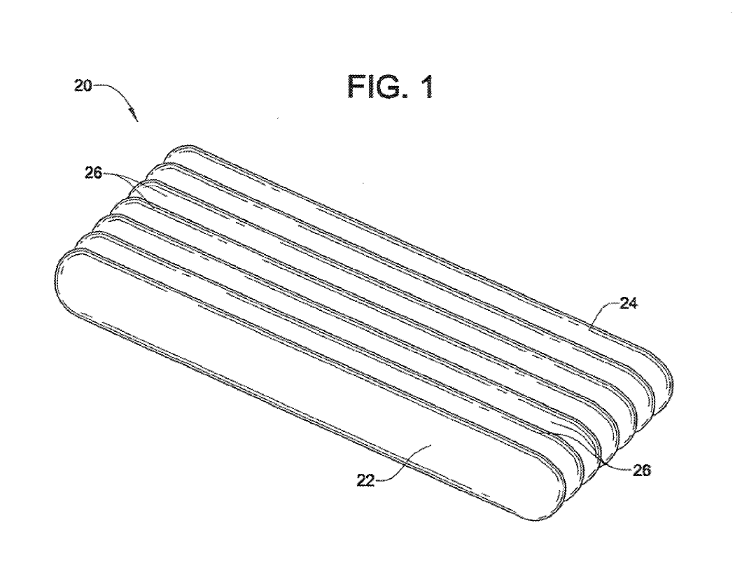

Referring now to FIG. 1, an example of a pressure vessel or tank assembly 20 configured to store a high pressure fluid is illustrated. Exemplary fluids that may be stored within the pressure vessel 20 include, but are not limited to, compressed natural gas (CNG), hydrogen, propane, methane, air, and hydraulic fluid, for example. The pressure vessel assembly 20 may generally include two flanking vessels 22, 24 and at least one interior vessel 26 (e.g., five identical interior vessels illustrated) joined to and disposed between the flanking vessels 22, 24. Each vessel 22, 24, 26 may generally be elongated with the overall configuration of the pressure vessel assembly 20 generally being a rectangular shape, beat as will, be appreciated from the description, herein, other shapes are contemplated.

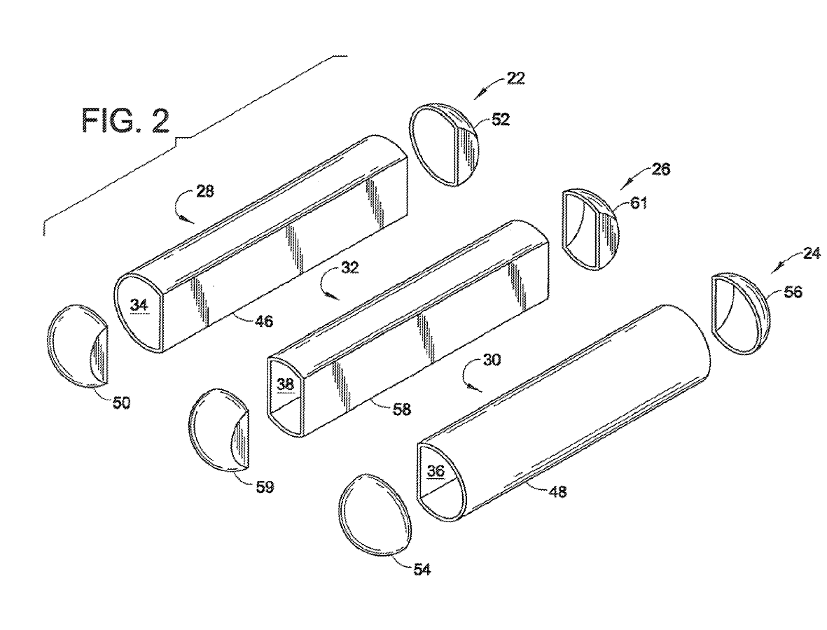

Referring to FIG. 2, each vessel 22, 24, 26 may include respective liners 28, 30, 32. Each liner 28, 30, 32 may define the boundaries of respective chambers 34, 36, 38 for the fluid storage. The flanking end liners 28, 30 may include respective lobes 46, 48 with lobe 46 closed-off by opposite end caps 50, 52 and lobe 46 closed-off by opposite end caps 54, 36. Each lobe 46, 48 may be circumferentially continuous and substantially cylindrical. The interior liner 32 may include a lobe 58 with the lobe 58 closed-off by opposite end caps 59, 61. Lobe 58 may be circumferentially continuous. The liners 28, 30, 32 may be made of any material and thicknesses capable of providing the necessary structural support, weight, operating characteristics, cost limitations and other parameters necessary for a particular application. Examples of liner material may include steel or other metallic compositions and plastic. The liners 28, 30, 32 may further be blow molded plastic, or injection molded plastic.

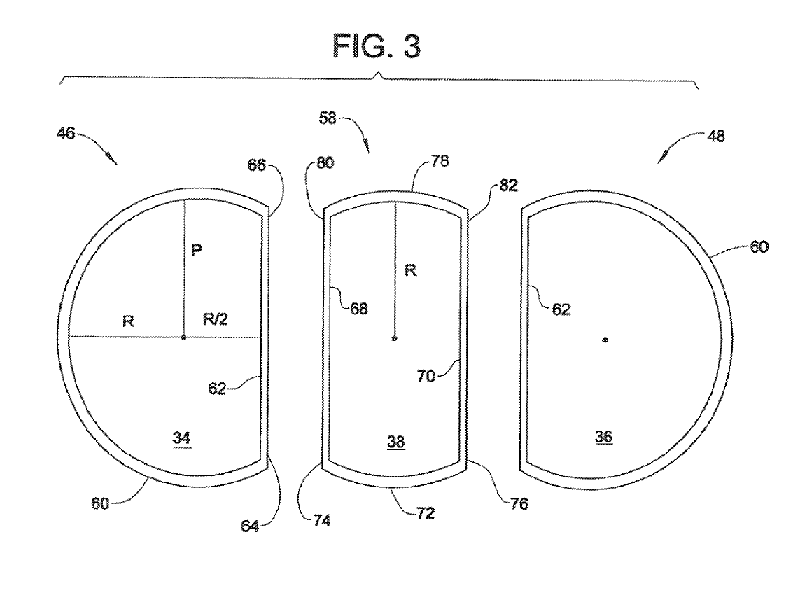

Referring to FIG. 3, the lobes 46, 48 of the respective flanking liners 28, 30 may be substantially identical and are arranged such that the lobe 46 of the first flanking liner 28 is rotated about one-hundred and eighty (180) degrees relative to the lobe 48 of the opposite flanking liner 30 (i.e., are arranged as a mirror image of one-another). Each flanking lobe 46, 48 may include a generally cylindrical outer portion or wall 60 and an interior portion or wall 62. The interior wall 62 may be substantially planar and may laterally span between a first end 64 and a second end 66 of the, cylindrical outer wall 60. In one embodiment, the interior wall 62 is integrally formed with the ends 64, 66 of the cylindrical outer wail 60. At least a portion of the curvature of the cylindrical outer wall 60 is defined by a radius R. In one embodiment, the portion of the outer wall 60, opposite the interior wall 62, includes a circular shape or curve generally of a two-hundred and forty (240) degree angle as defined by the radius R. Consequently, the overall height of the flanking lobes 46, 48 is equal to double the length of the radius R of the cylindrical outer wall 60. The vertical interior wall 62 is generally parallel to and spaced apart from a vertical plane P that includes the origin of the radius R that defines the curvature of the outer wall 60. In one embodiment, the distance between the interior wall 62 and the parallel vertical plane P about half the length of the radius R. As a result, the flanking lobes 46, 48 generally have a width equal to about one and a half the length of the radius of curvature R of the outer wall 60.

The illustrated interior lobe 58 includes first and second interior sidewalls 68, 70 that may be diametrically opposite one another, substantially vertically arranged, and separated from one another by a distance. In one embodiment, the width of the interior lobe 58 is generally equal to the radius of curvature R of the end lobes 46, 48. The thicknesses of the first interior sidewall 68 and the second interior sidewall 70 may be identical and may be equal to the thickness of the interior wall 62 of the flanking lobes 46, 48. A first outside wall 72 extends between a first end 74 of the first interior sidewall. 68 and a first end 76 of the second interior sidewall 70. Similarly, a second outside wall 78 extends between a second end 80 of the first interior sidewall 68 and a second end 82 of the second interior sidewall 70.

The curvature of the first outside wall 72 and the second outside wall 78 may be defined by a circular shape or curve generally of a sixty (60) degree angle by a radius R. In one embodiment, the radius of curvature R of the interior lobe 58 is substantially identical to the radius of curvature R of the flanking lobes 46, 48. Consequently, the distance between the first curved wall 72 and the second curved wall 78 is double the length of the radius of curvature R, and is therefore, substantially equal to the height of the flanking lobes 46, 48.

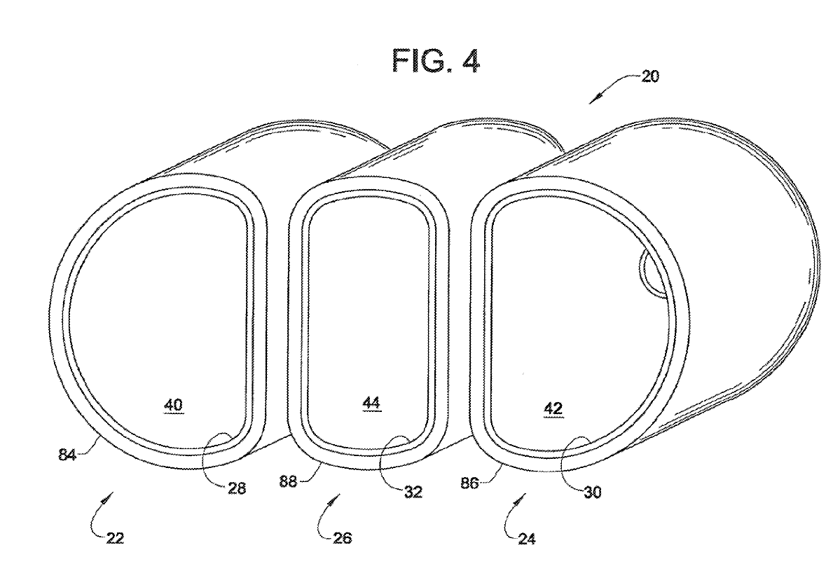

Referring to FIG. 4, the vessels 22.24, 26 each include a mid-layer 84, 86, 88 that substantially covers the respective liners 28, 30, 32. The mid layer 84 may a continuous fiber wrapping or prepregs (i.e., fiber with resin) wrapped about the lobes and end caps of the liners for structural strength and for distributing internal stress. Alternatively, the mid-layers 84, 86, 88 may include a braiding that wraps about the respective liners 28, 30, 32. The primary reinforcement (i.e., the fibers or braiding), may be made of a carbon fiber, a glass fiber or an aramid fiber. A matrix material or resin for binding the continuous fibers may include epoxy, vinyl ester and other resin systems that may be nano-enhanced. It is further contemplated and understood that the mid-layers 84, 86, 88 may be made of resin impregnated fibers that may be chopped. As one example, the chopped fibers may be about one (1) inch (2.54 cm) in length.

When the pressure vessel assembly 20 is at least partially assembled, the interior wall 62 of the flanking lobe 46 is opposed and in proximity to the interior sidewall 68 of the interior lobe 58. The portion of the mid-layer 84 covering the interior wall 62 may be directly adjacent and adhered to the portion of the mid-layer 88 that covers the sidewall 68 if a binder is present. Similarly, the interior wall 62 of the flanking lobe 48 is opposed and in proximity to the interior sidewall 70 of the interior lobe 58. The portion of the mid-layer 86 covering the interior wall 62 may be directly adjacent and adhered to the portion of the mid-layer that covers the sidewall 70.

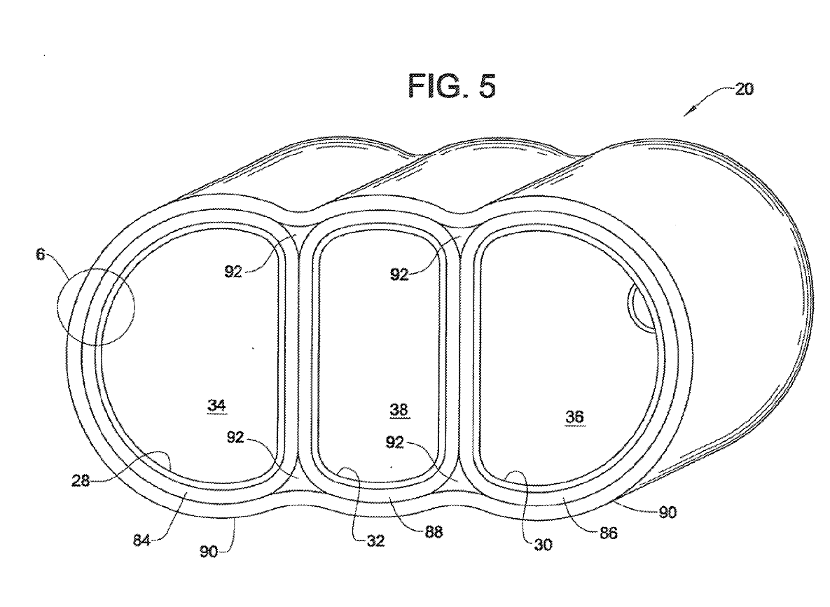

Referring to FIG. 5, the pressure vessel assembly 20 may include an outer layer 90 that generally covers and envelops the mid-layers 84, 86, 88. The outer layer 90 may be applied after the mid-layers 84, 86, 88 are joined. The outer layer 90 may be a mixture of a chopped fiber and resin that may be spray applied (i.e., spray chop fiber/resin) or may be a sheet molding compound (SMC). The primary reinforcement (i.e., the chopped fibers), may be made of a carbon fiber, a glass fiber or a aramid fiber of about one (1) inch in length (2.5 cm). The resin for binding the chopped fibers may include epoxy, vinyl ester and other resin systems that may be nano-enhanced.

The pressure vessel assembly 20 may further include a plurality of junctions 92 with each junction located where respective ends of the outer walls 60, 72, 78, ends of the sidewalls 68, 70, and ends of interior walls 62 generally meet. Each junction 92 may generally be Y-shaped (i.e., a three pointed star) and may be made of the same material as the outer layer 90.

Because of the use of the continuous fiber in the mid-layers 84, 86, 88, the vessel assembly 20 weight is much lighter than if the entire assembly were made with a chopped fiber. However, the internal structural sidewalls 68, 70 and internal walls 62 have different mechanical properties from the outer walls 60, 72, 78 with the hybrid of continuous fiber and chopped fiber. The internal structural sidewalls 68, 70 and internal walls 62 will have a higher modulus of elasticity than the hybrid outer walls 60, 72, 78, and therefore the junctions 92 will require an optimized angle that is different from about one-hundred and twenty (120) degrees that would typically be derived from homogeneous materials. The junction 92 angle and the internal wall thickness will be optimized based on specific material properties.

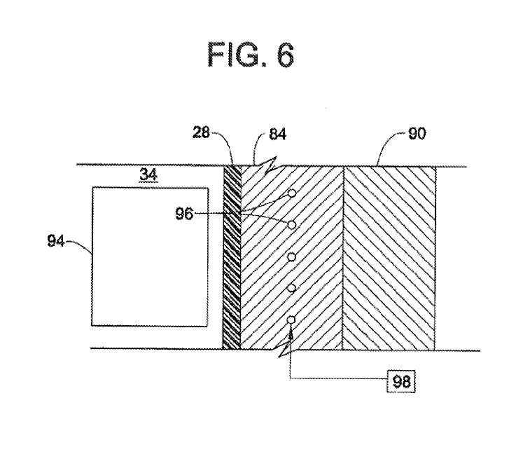

Referring to FIGS. 5 and 6, the pressure vessel assembly 20 may further include an absorbent 94 (i.e., gas absorbent media) located in one or all of the chambers 34, 36, 38. The absorbent 94 functions to stipple:merit the gas storage capacity of the pressure vessel assembly 20. The absorbent 94 may be in granular or pellet thrill, or may be formed into any desirable shape. Non-limiting, examples of absorbents 94 may depend, at least in-part, on the type of gas being stored. For example, if the gas is hydrogen, the absorbent 94 may include metal organic frameworks, active carbon, metal hydrides, carbon nano tubes, and others. If the gas is CNG, the absorbent 94 may include activated carbon, metal organic frameworks, and others.

The pressure vessel assembly 20 may also include a heating element 96 adaptable to heat the absorbent: 94 for improved extraction of the fluid or gas therefrom. The heating element 96 may be embedded in, for example, the mid layer 84. Moreover, each chamber 34, 36, 38 may contain an absorbent 94 and a separate heating element 96 may be embedded in each mid-layer 84, 86, 88. It is further contemplated and understood, that one heating element 96 may heat the absorbent(s) 94 located in all three chambers 34, 36 38, and the single heating element may generally be embedded in the outer layer 90. In vet another embodiment, one or more heating elements 96 may be disposed and embedded between the mid-layers 84, 86, 88 and the outer layer 90.

Non-limiting examples of the heating element 96 may include devices configured to convert electrical energy to thermal energy and hydronic devices constructed to now heated fluids. Examples of the embedded portions of the electrical device may include metal wire, copper foil, carbon nano tubes and others. Yet further, in the above mentioned example where the polymer matrix composite of the mid-layers 84, 86, 88 includes a continuous carbon fiber reinforcement, the carbon fiber itself may serve as a portion of an electrical circuit that emits thermal energy. If the heating element 96 is part of a hydronic device, the heating element(s) 96 may be tubes embedded in the mid-layers 84, 86, 88 and configured to how a heated fluid (i.e., liquid tinder gas). The heating element type may be based on desired characteristics such as -weight, heating efficiency and cost.

In another embodiment, the composite material of the mid-layers 84, 86, 88 and/or the outer layer 90 may include a glass fiber for structural reinforcement, and which also functions as an electrical insulation. Moreover, the heating element 96 may also function as part of a vessel structural health monitoring system 98 capable of detecting, for example, any discontinuity or breakage of the heating elements 96.

The heating elements 96 may be embedded in the mid-layers 84, 86, 88 during the manufacturing process of the pressure vessel assembly 20. The heating elements 96 may be placed at an optimal depth within the layers 84, 86, 88 to maximize heating efficiency and minimize the heating element electrical load.

The composite pressure vessel assembly 20 may provide a lightweight storage tank with as high energy Storage density. The approach enables the easy addition of reinforcing composite material where needed (e.g. junctions 92). The use of the hybrid continuous and short fiber may further minimize the vessel assembly weight. Because the vessel assembly 20 may be in a non-cylindrical shape, the assembly will provide the highest conformability to a given space. Moreover, the composite construction wilt also provide corrosion resistance compared to metallic tanks.

The integrated hearing elements 96 in the composite material with the absorbent 94 will maximize the gas usage in all weather conditions. The present disclosure provides a simplified and cost effective approach in integrating heating elements 96 and associated terminals into the composite pressure vessel assembly 20 during the manufacturing process.

While the present disclosure is described with reference to exemplary embodiments, it will be understood by those skilled in the an that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A pressure vessel assembly comprising:
a first composite layer surrounding at least one chamber, and a first heating element embedded in the first composite layer.

2. The pressure vessel assembly set forth in claim 1 further comprising:
a first absorbent disposed in at least one of the at least one chamber.

3. The pressure vessel assembly set forth in claim 2, wherein the first composite layer comprises a polymer matrix composite.

4. The pressure vessel assembly set forth in claim 2, wherein the first heating element is selected from the group comprising metal wire, copper foil and carbon nano tubes.

5. The pressure vessel assembly set forth in claim 2, wherein the first composite layer comprises continuous carbon fibers, and the heating element includes the continuous carbon fibers.

6. The pressure vessel assembly set forth in claim 2, wherein the pressure vessel assembly is configured to store natural gas and the first heating element is configured to heat the absorbent to extract the natural gas.

7. The pressure vessel assembly set forth in claim 1, wherein the first heating element is configured to be a portion of a vessel structural health monitoring device.

8. The pressure vessel assembly set forth in claim 1 further comprising:
a first liner defining a first chamber of the at least one chamber, and wherein the first liner is encompassed by the first composite layer.

9. The pressure vessel assembly set forth in claim 8, wherein the first liner is selected from the group comprising blow molded plastic and injection molded plastic.

10. The pressure vessel assembly set thrill in claim 8 further comprising:
a second liner defining a second chamber of the at least one chamber, and wherein the first and second liners arc encompassed by the first composite layer.

11. The pressure vessel assembly set forth in claim 8 further comprising:
a second liner defining a second chamber of the at least one chamber; and
a second composite layer joined with and enveloping the second liner, and wherein the first liner is joined and enveloped by the first composite layer, and portions of the first and second composite layers are joined.

12. The pressure vessel assembly set forth in claim 11 further comprising:
a second heating element embedded in the second composite layer.

13. The pressure vessel assembly set forth in claim 12 further comprising:
a third composite layer joined with and enveloping the first and second composite layers.

14. The pressure vessel assembly set forth in claim 10 further comprising:
a second absorbent disposed in the second chamber.

15. The pressure vessel assembly set forth in claim further :comprising:
a second absorbent disposed in the second chamber.

16. The pressure vessel assembly set forth in claim 13, wherein the third composite layer comprises a glass fiber.

17. A composite pressure vessel assembly comprising:
a liner defining a chamber and comprising blow molded plastic;
a layer joined with and enveloping the liner, and wherein the layer comprises a polymer matrix composite:
an absorbent disposed in the chamber; and
a heating element embedded in the layer.

18. The composite pressure vessel assembly set forth in claim 17, wherein the polymer matrix composite includes a reinforcement fiber selected from the group comprising a carbon fiber, a glass fiber and an aramid fiber.

19. The composite pressure vessel assembly set forth in claim 17, wherein the heating element is configured to convert electrical energy to thermal energy and is selected from the group comprising metal wire, copper foil and carbon nano tubes.

20. The composite pressure vessel assembly set forth in claim 17, wherein the heating element is configured to apply hydronic heat and includes tubes embedded in the layer for flowing a heated fluid.
